(19) United States
(12) Patent Application Publication
(10) Pub. No.: US 2023/0153872 A1
(43) Pub. Date: May 18, 2023

(54) ELECTRONIC LEDGER FOR DECISION-INFLUENCING FACTORS

(71) Applicant: Net Alpha Financial Systems, LLC, West Bloomfield, MI (US)

(72) Inventors: Eyal Mizrahi, West Bloomfield, MI (US); Rami Mizrahi, Tel Mond (IL); Daniel Goland, Pacific Palisades, CA (US); Michael Pedersen, Ann Arbor, MI (US); Tamir Shalom, Tel Aviv (IL); Dekel Yossef, Matan (IL)

(21) Appl. No.: 17/988,126

(22) Filed: Nov. 16, 2022

Related U.S. Application Data
(60) Provisional application No. 63/280,422, filed on Nov. 17, 2021.

(51) Int. Cl. G06Q 30/02; G06F 16/18

(52) U.S. Cl. CPC G06Q 30/0283; G06F 16/1805

(57) ABSTRACT

A method and system for generating and maintaining an immutable electronic ledger. The method comprises receiving, accessing, and/or modifying one or more decision-influencing factors relating to a commodity and/or a product. The method comprises autonomously storing the one or more decision-influencing factors as a part of the immutable electronic ledger in response to said receiving, accessing, and/or modifying. The immutable electronic ledger serves as a record of decision-influencing factors, that is free of hindsight, for a business entity in an evaluation of a decision associated with the commodity and/or product and influenced by the one or more decision-influencing factors.

### CROSS-REFERENCE TO RELATED APPLICATIONS

This application claims priority to U.S. Provisional Pat. Application No. 63/280,422, entitled ELECTRONIC LEDGER FOR DECISION-INFLUENCING FACTORS, filed on Nov. 17, 2021, the entirety of which is incorporated by reference herein and made a part of the present specification.

### FIELD

The present disclosure relates to an immutable electronic ledger. The ledger may be particularly advantageous to serve as a record of decision-influencing factors for a business entity making decisions which are impacted by variable prices of commodities.

### BACKGROUND

Commodity producers supply industries with the raw materials for producing products while commodity pricing is greatly affected by supply and demand, among other factors, with such pricing determined by buyers and sellers that carry out physical transactions and on commodity markets where futures and other financial instruments are traded. Purchasing commodities is an act attendant with financial risk. As prices fluctuate over time, at least one goal of researching and executing personnel is to obtain commodities at the lowest possible price in a period of time.

In furtherance of this goal, researching and executing personnel perform their own research, construct their own forecasts, and consult the research and forecasts of others. Generally, there are two types of market forecasts referenced by researching and executing personnel. One is a price forecast report, which tabulates forecasted prices on a weekly, monthly, or quarterly basis for different types of commodities. These reports are authored by analysts, and differences may be observed between the forecasts of different reporting sources. The other is a forward price curve, which graphs forecasted prices over time. These curves represent current worth of a commodity that will be bought or sold in the future. In other words, the curves reflect current-day transactions in commodity futures contracts for commodities that will be bought or sold in the future during the life of the contracts.

Prices that are updated periodically (e.g., daily, weekly, monthly, etc.) may also be considered by researching and executing personnel. Decisions can be taken upon the resulting changed prices. As such, business entities typically would like to determine triggers so that they will be alerted when such triggers are reached. An example for such an alert is when an updated price or forecast reaches a specific value.

In addition to prices or to price forecasts, business entities might rely on indexes (e.g., those published by U.S. Bureau of Labor Statistics) to determine the outcome of contracts, to take decision upon these indexes, etc. Thus, enabling to align such indexes to timeline is most helpful for such business entities. Alerts that are triggered by such indexes or formulas will also be helpful.

In the course of business, researching and executing personnel generally have to communicate decisions impacted by raw material pricing to other organizational stakeholders. These stakeholders may be laypersons in the world of commodities markets, or they may be savvy market professionals. Even if they are not laypersons, it is incumbent on researching and executing personnel to provide to these stakeholders succinct and easily comprehensible data upon which their decisions are based. At least one reason for this need is the transience of commodities prices. If a decision-making process takes too long, then the market can change and the underlying basis for a decision is undermined. In this case, a new analysis may need to be initiated and the time and effort expended thus far could be rendered, at least in part, unproductive.

Price forecast reports provided by conventionally authoritative sources can list hundreds of different types of commodities and the tabular format is not easily accessible or navigable. Data typically has to be extracted from these reports and managed by the researching and executing personnel, which is a time-consuming exercise and the method by which researching and executing personnel do so can vary between persons. Forward price curves are already presented in a succinct and easily comprehensible format. However, the curves are limited to current-day transactions and do not account for real-time news or expert commentary. Moreover, researching and executing personnel may modify the forecasts in price forecast reports and forward price curves in view of their own knowledge and beliefs.

Multiple tools may be employed during decision-making processes. Market research can be accessed via an internet browser. Electronic spreadsheet software may be employed to record data, perform calculations upon data, and generate visualizations of data. Email clients or instant messaging platforms can be used for communications between different parties. Specialized software such as enterprise resource planning software may be accessed to retrieve information and input information. In other words, users have to toggle between different screens and/or windows in a graphical user interface to access or view these tools.

Researching and executing personnel are tasked with making decisions with a potentially large magnitude of financial consequence for the business entity they work for. Even the decision to wait a week to purchase a commodity can be risky. If the commodity’s price rises just 2% in that week-long period, a formerly $1,000,000 transaction increases in price by $20,000. Needless to say, the decisions of researching and executing personnel are under a great deal of scrutiny. Thus, researching and executing personnel may need to revert back to their records to learn from their past decisions towards future decision making. These records may be stored in various digital locations, which makes it difficult and time-consuming to retrieve all of the data. These records may be stored in different digital file formats, which makes it difficult and time-consuming to assemble succinct, cohesive data packages for review by a business entity. Moreover, different digital file formats can hinder data extraction efforts by way of software tools. These records may be stored in transient storage media, which may be erased or altered. These records may not have been initially saved in the first place and will thus be impossible to produce in the future.

Moreover, other decisions by a business entity may be affected by commodity prices. For example, it may be decided to construct a product with an alternative raw material. As another example, the business entity may decide to forego purchasing new equipment so that cash reserves may be sequestered for raw material purchases. An electronic record of the factors influencing such decisions allows the decision-making process to be reviewed in the future and can provide data to inform future decision-making processes.

It would be desirable to provide an immutable electronic ledger for saving decision-influencing factors referenced or produced leading up to decisions impacted by, for example, changing prices of commodities or raw materials.

It would be desirable to provide an immutable electronic ledger for saving only those decision-influencing factors available at the time of a decision or evaluation process and not afterward. It would be desirable to provide an immutable electronic ledger that eliminates hindsight from future review of a past decision or evaluation process.

It would be desirable to provide an immutable electronic ledger that maintains some chosen documents, including internal documents, and align them to a timeline for ease of revisiting them in the future, such that within a certain time frame, decision-influencing factors that were known and/or considered at that time frame and contributed to a decision can be evaluated.

It would be desirable for decision-influencing factors to be autonomously saved to avoid missing data.

It would be desirable for an immutable electronic ledger to be centralized.

It would be desirable to provide an electronic ledger in an immutable format so that the record cannot be altered or erased.

It would be desirable to provide an immutable electronic ledger to provide reliable business records of one or more transactions.

It would be desirable to provide a succinct and easily comprehendible report of decision-influencing factors that is accessible to stakeholders, both laypersons and experts alike.

It would be desirable to provide for expedient communications between researching and executing personnel and stakeholders to mitigate or even substantially avoid delay in making a decision and executing in accordance with this decision.

It would be desirable to provide for a user interface that neatly and succinctly graphically presents relevant decision-influencing factors within a single page or window to avoid users having to navigate to different locations for information.

It would be desirable to provide for a user interface that enables setting alerts related to decision-influencing factors and informing a user once these alerts have been triggered.

### SUMMARY

The present disclosure relates to a method for generating and maintaining an immutable electronic ledger, which may address at least some of the needs identified above.

The method may comprise receiving, by one or more computing devices, one or more price forecasts of one or more commodities and/or products from one or more users and/or one or more third party sources.

The method may comprise autonomously storing, by one or more memory storage media, the one or more price forecasts as a part of the immutable electronic ledger. The one or more price forecasts may be identified by a date and time of storage.

The method may comprise receiving, by the one or more computing devices, one or more simulated purchases, one or more simulated sales, one or more simulated utilizations, or any combination thereof from one or more users.

The method may comprise autonomously storing, by the one or more memory storage media, the one or more simulated purchases, the one or more simulated sales, the one or more simulated utilizations, or any combination thereof as a part of the immutable electronic ledger. The one or more simulated purchases, the one or more simulated sales, the one or more simulated utilizations, or any combination thereof may be identified by a date and time of storage.

The method may comprise autonomously calculating, by the one or more computing devices, a price outcome of the one or more simulated purchases, the one or more simulated sales, the one or more simulated utilizations, or any combination thereof. The calculation may be based upon the one or more price forecasts.

The method may comprise autonomously storing, by the one or more memory storage media, the price outcome, as a part of the immutable electronic ledger. The price outcome may be identified by a date and time of storage.

Storage as a part of the immutable electronic ledger may autonomously occur upon initial receipt by the one or more computing devices, access by the one or more users, or any change effectuated by the one or more users.

The immutable electronic ledger may serve as a record of decision-influencing factors for a business entity in an evaluation of a decision influenced by a price of the one or more commodities.

The method may comprise receiving, by the one or more computing devices via a network, historical price data. The method may comprise autonomously storing, by the one or more memory storage media, the historical price data as a part of the immutable electronic ledger. The historical price data may be identified by a date and time of storage.

The method may comprise receiving, by the one or more computing devices via the network, market commentary and/or news.

The method may comprise autonomously storing, by the one or more memory storage media, the market commentary and/or the news as a part of the immutable electronic ledger. The market commentary and/or news may be identified by a date and time of storage.

The method may comprise receiving, by the one or more computing devices, labor data, currency exchange rates, inflation rates, logistical costs, schedules, premiums, discounts, or any combination thereof.

The method may comprise autonomously storing, by the one or more memory storage media, the labor data, the currency exchange rates, the inflation rates, the logistical costs, the schedules, the premiums, the discounts, or any combination thereof as a part of the immutable electronic ledger. The labor data, the currency exchange rates, the inflation rates, the logistical costs, the schedules, the premiums, the discounts, or any combination thereof may be identified by a date and time of storage.

The method may comprise receiving, by the one or more computing devices, updated prices, indexes, documents, historical index data, or any combination thereof.

The method may comprise autonomously storing, by the one or more memory storage media, the updated prices, indexes, documents, historical index data, or any combination thereof. The updated prices, indexes, documents, historical index data, or any combination thereof may be identified by a date and time of storage.

The method may comprise transmitting, by one or more first computing devices of one or more first users (e.g., researching and executing personnel), via the network, the one or more price forecasts, the one or more simulated purchases, the one or more simulated sales, the one or more simulated utilizations, the historical price data, the market commentary, the news, the labor data, the currency exchange rates, the inflation rates, the logistical costs, the schedules, the premiums, the discounts, or any combination thereof to one or more second computing devices of one or more second users (e.g., stakeholders).

The method may comprise receiving, by the one or more first computing devices via the network, one or more communications from the one or more second computing devices.

The method may comprise receiving, by the one or more second computing devices via the network, one or more communications from the one or more first computing devices.

The method may comprise autonomously storing, by the one or more memory storage media, the one or more communications between the one or more first computing devices and the one or more second computing devices as a part of the immutable electronic ledger identified by a date and time of storage.

Instead of autonomously storing, the storing may occur at the direction of the one or more users.

The step of receiving the one or more price forecasts and/or the step of receiving the one or more simulated purchases, the one or more simulated sales, the one or more simulated utilizations, or any combination thereof may be repeated to generate different scenarios.

The method may comprise receiving, by the one or more computing devices, a designation of each scenario as a best-case scenario, a worst-case scenario, or a most probable scenario.

The method may comprise autonomously storing, by the one or more memory storage media, the designation as a part of the immutable electronic ledger identified by a date and time of storage.

The method may comprise displaying, by a graphical user interface, contents of the immutable electronic ledger relating to the evaluation of the decision. The contents of the immutable electronic ledger may include only data available contemporaneously with the evaluation of the decision.

The method may comprise displaying, by a graphical user interface, contents of the immutable electronic ledger including the one or more price forecasts, the one or more simulated purchases, the one or more simulated sales, the one or more simulated utilizations, or any combination thereof, compared against actual historic prices, actual purchases, actual sales, actual utilizations, or any combination thereof.

The method may comprise displaying, by a graphical user interface, an overlay of two or more price forecasts of different scenarios related to different decision evaluations over time. The different decision evaluations may relate to the same and/or different commodities and/or products.

The method may comprise displaying, by a graphical user interface, an overlay of two or more price forecasts of different scenarios related to the same decision evaluation.

The method may comprise generating, by one or more processors, guidelines based upon one or more decision evaluations. The guidelines may be adapted to be employed for training purposes and/or to set forth best practices.

The method may comprise generating, by one or more processors, combination of different evaluations of different commodities, where the different commodities are utilized for the production of alloys, mixtures, and/or blends.

The one or more price forecasts may include forecasted prices of the commodity and/or product at one or more future dates.

Each of the one or more simulated purchases may include a quantity of the commodity and/or product to be purchased or considered to be purchased by the business entity at a future date at each of the one or more forecasted prices.

Each of the one or more simulated sales may include a quantity of the commodity and/or product to be sold or considered to be sold by the business entity at a future date at each of the one or more forecasted prices.

Each of the one or more utilizations may include a quantity of the commodity and/or product to be utilized or considered to be utilized by the business entity to produce a quantity of products at a future date.

The one or more price forecasts receiving step may be performed by extracting, by the one or more computing devices, one or more price forecasts data from the one or more third party sources. The one or more third party sources may be accessible by the one or more computing devices via a network.

The one or more third party sources may be network-accessible websites of publishers of market data.

The receiving steps may be performed by one or more user interfaces of the one or more computing devices.

The calculating step may be performed by one or more processors of the one or more computing devices. The one or more processors may be hardware local to the one or more computing devices, located in a cloud server, or both.

The immutable electronic ledger may be centralized, such that a central authority controls the data stored in the immutable electronic ledger.

The immutable electronic ledger may be stored on a single memory storage medium.

The one or more memory storage media may be hardware local to the one or more computing devices, located in a cloud server, or both.

The one or more memory storage media may be located on a computing device of the business entity.

The method may comprise defining one or more conditions which triggers one or more alerts when met. The one or more conditions may be related to the one or more decision-influencing factors. The alerts may be triggered as a result of existing conditions that depend on one or more price forecasts, updated prices, indexes, or any combination thereof. The condition for triggering the alert may account for the one or more price forecasts and/or the one or more updated prices.

The method may comprise defining a rule associated with the one or more decision-influencing factors. The rule may include capping, pricing adjustment after partial absorption (layering) of the price or index change.

The present disclosure relates to a system for generating and maintaining an immutable electronic ledger, which may address at least some of the needs identified above.

The system may comprise one or more first computing devices operated by one or more first users (e.g., researching and executing personnel).

The system may comprise one or more second computing devices operated by one or more second users (e.g., stakeholders).

The system may comprise one or more memory storage media for storing an immutable electronic ledger.

The immutable electronic ledger may serve as a record of decision-influencing factors for a business entity in an evaluation of a decision influenced by a price of one or more commodities.

The system may comprise a network enabling communication between the one or more first computing devices and the one or more second computing devices.

The network may enable the one or more first computing devices and/or the one or more second computing devices to receive historic price data, market commentary, news, labor data, currency exchange rates, inflation rates, logistical costs, schedules, premiums, discounts, or any combination thereof.

The first computing device and one or more second computing devices may each comprise a processor for executing computer-readable instructions (e.g., calculating and/or generating).

The first computing device and one or more second computing devices may each comprise a memory storage medium for storing data, and a network module for communicating via a network.

The immutable electronic ledger may be centralized, such that a central authority controls the data stored in the immutable electronic ledger.

The one or more memory storage media may be local to the one or more first computing devices, local to the one or more second computing devices, located in a cloud server, or any combination thereof.

The one or more memory storage media may be located on one or more computing devices of the business entity.

The present disclosure relates to a method for generating and maintaining an immutable electronic ledger, which may address at least some of the needs identified above.

The method may comprise receiving, by one or more computing devices, one or more decision-influencing factors relating to a price of one or more commodities.

The method may comprise autonomously storing, by one or more memory storage media, the one or more decision-influencing factors as a part of the immutable electronic ledger.

Storage as a part of the immutable electronic ledger may autonomously occur upon initial receipt by the one or more computing devices, access by the one or more users, or any change effectuated by the one or more users.

The immutable electronic ledger may serve as a record of decision-influencing factors for a business entity in an evaluation of a decision influenced by a price of the one or more commodities. The record may only contain data available at the time of the decision or evaluation process. The record may be free of hindsight. That is, the record may be free of any data available after the time of the decision or evaluation process.

The one or more decision-influencing factors may include one or more price forecasts, simulated purchases, simulated sales, simulated utilizations, historical price data, market commentary, news, labor data, currency exchange rates, inflation rates, logistical costs, schedules, premiums, discounts, updated prices, indexes, documents, historical index data, or any combination thereof.

The method may comprise transmitting, by one or more first computing devices of one or more first users (e.g., researching and executing personnel), via a network, one or more decision-influencing factors to one or more second computing devices of one or more second users (e.g., stakeholders).

The method may comprise receiving, by the one or more first computing devices via the network, one or more communications from the one or more second computing devices.

The method may comprise receiving, by the one or more second computing devices via the network, one or more communications from the one or more first computing devices.

The method may comprise autonomously storing, by the one or more memory storage media, the one or more communications between the one or more first computing devices and/or the one or more second computing devices as a part of the immutable electronic ledger identified by a date and time of storage.

The method may be employed in the decision to purchase one or more commodities.

The method may be employed in the decision to sell one or more commodities.

The method may be employed in the decision to price one or more products produced from one or more commodities.

The method may be employed in the decision to set an inventory policy and/or sales policy of one or more commodities.

Instead of autonomously storing, the storing occurs at the direction of the one or more users.

The method may comprise displaying, by a graphical user interface, contents of the immutable electronic ledger relating to the evaluation of the decision.

The contents of the immutable electronic ledger may include only data available contemporaneously with the evaluation of the decision.

The decision-influencing factor receiving step may be performed by extracting, by the one or more computing devices, decision-influencing factor data from one or more third party sources.

The one or more third party sources may be accessible by the one or more computing devices via a network.

The one or more third party sources may be network-accessible websites of publishers of market data.

The receiving steps may be performed by one or more user interfaces of the one or more computing devices.

The immutable electronic ledger may be centralized, such that a central authority controls the data stored in the immutable electronic ledger.

The immutable electronic ledger may be stored on a single memory storage medium.

The one or more memory storage media may be hardware local to the one or more computing devices, located in a cloud server, or both.

The one or more memory storage media may be located on one or more computing devices of the business entity.

### DETAILED DESCRIPTION

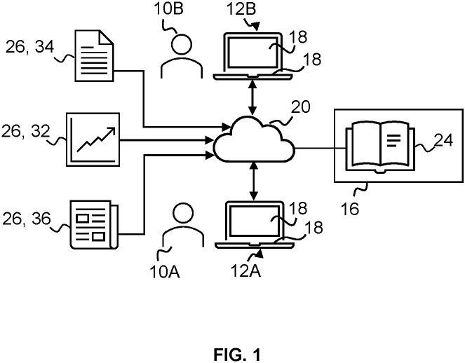

FIG. 1 illustrates a system according to the present teachings.

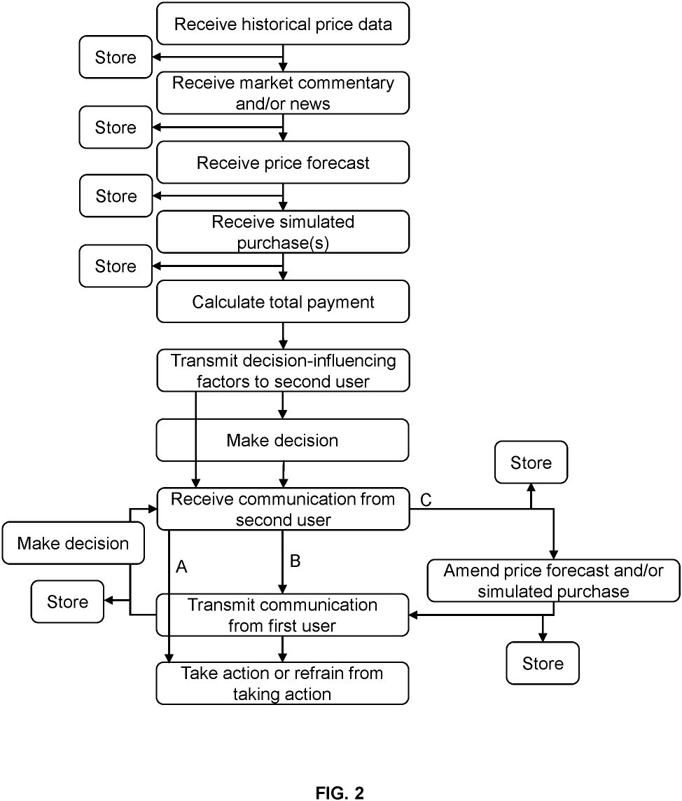

FIG. 2 illustrates a method according to the present teachings.

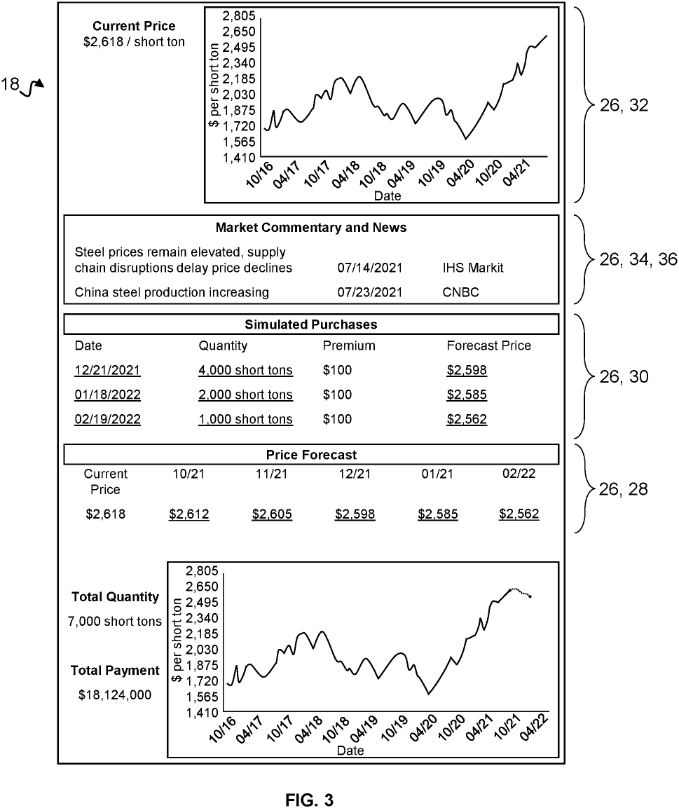

FIG. 3 illustrates a user interface.

### DETAILED DESCRIPTION

### Introduction

The present teachings meet one or more of the above needs by the improved method and system described herein. The present disclosure is related to a method performed by a system comprising one or more computing devices. The method may be embodied by computer-readable instructions that may be executed by one or more processors of the one or more computing devices and/or one or more cloud-based processors. The computer-readable instructions may be stored on one or more non-transient memory storage media of the one or more computing devices. The computing devices may receive inputs from one or more users (e.g., researching and executing personnel, stakeholders, or both). The inputs may be received by one or more user interfaces. The inputs may be converted into digital signals that are employed by the computer-readable instructions of the present method.

The method and system of the present disclosure may find application in decision-making affected by the prices of one or more commodities. This may include the purchasing of commodities, the selling of commodities, the utilization of commodities for goods and/or services, the pricing of one or more products produced from one or more commodities, setting the inventory policy and/or sales policy of one or more commodities, or any combination thereof.

By way of example, the decision to purchase a commodity may be affected by the price where a business entity may typically benefit from purchasing the commodity at a relatively low price.

By way of another example, the decision to sell a commodity may be affected by the price where a business entity may typically benefit from selling the commodity at a relatively high price.

By way of yet another example, the decision to utilize a commodity for goods and/or services may be affected by the price where a business entity typically benefits from ensuring the procurement of commodities at a favorable price meets the demand (e.g., production schedule, customer order volume, and the like) for the provision of goods and/or services.

Decision-making affected by the prices of one or more commodities may include the purchasing of products, the selling of products, the utilization of products for goods and/or services, or any combination thereof. The products may be produced from commodities. Thus, the price of the commodities the product is comprised of affects the pricing of the product itself.

By way of example, a mobile phone may comprise a processor and a memory storage medium. Electrical connections of the processor and memory storage medium may be fabricated from gold and the board may be fabricated from silicon. Thus, the pricing of gold and silicon may affect the pricing of the mobile phone. In other words, the decision of what price to apply to the mobile phone is affected by the pricing of the commodities the phone is comprised of.

As referred to herein, “utilization” for goods may mean manipulating commodities by fabrication techniques, chemical blending, chemical reactions, the like, or any combination thereof, to produce a product or an intermediate thereof.

As referred to herein, “utilization” for services may include using commodities during the course of providing services. By way of example, a business entity providing industrial cleaning services may utilize cleaning chemicals for the provision of those services.

The commodities may include any commodity typically traded on a commodity market. The commodities may be raw materials. The raw materials may be employed to produce products. The raw materials and/or commodities may be tracked by price indices. Commodities and raw materials may be referred to interchangeably herein. The commodities may include, without limitation, polymers, chemical precursors, crude oil, natural gas, precious metals, industrial metals, minerals, grains, food, fibers, livestock, the like, or any combination thereof.

The products may include any product produced by a variety of industries, the products being produced from commodities. The products may include, without limitation, vehicles, electronics, machinery, infrastructure, buildings, appliances, clothing, furniture, pharmaceuticals, fuel, cleaning products, the like, or any combination thereof.

The method and system of the present disclosure may be employed by one or more users. The users may include researching and executing personnel. The researching and executing personnel may be, without limitation, purchasing managers, sales managers, inventory managers, production managers, the like, or any combination thereof. The researching and executing personnel may be an agent of a business entity.

The researching and executing personnel may be tasked with researching purchasing decisions, purchasing commodities and/or products, or both. The researching and executing personnel may seek to purchase commodities and/or products at prices that are favorable to the business entity. The researching and executing personnel may seek to avoid expending too much money for commodities and/or products that are purchased.

The researching and executing personnel may be tasked with researching selling decisions, selling commodities and/or products, or both. The researching and executing personnel may seek to sell commodities and/or products at prices that are favorable to the business entity. The researching and executing personnel may seek to obtain the highest possible price for the commodities and/or products that are sold.

The researching and executing personnel may be tasked with researching utilization decisions, utilizing commodities and/or products, or both. The researching and executing personnel may seek to utilize commodities and/or products in production to meet supply and demand constraints. The researching and executing personnel may seek to obtain commodities and/or products at rates and quantities commensurate with the sale of the commodities and/or products to customers.

The researching and executing personnel may perform research to determine when, at what price, and in what quantity commodities and/or products should be purchased and/or sold in the future. The researching and executing personnel may devise forecasts of commodity and/or product prices in the future. The researching and executing personnel may rely on pricing forecasts devised and provided by third party sources. The third-party sources may be published and/or authored by, without limitation, financial analysts, financial institutions, the like, or any combination thereof. The third-party sources may be network-accessible websites of publishers and/or authors of commodity market data. The researching and executing personnel may devise their own pricing forecasts with the assistance of pricing forecasts devised and provided by the third-party sources. The researching and executing personnel may devise forecasts based upon historic price data, market commentary, news, the like, or any combination thereof. The researching and executing personnel may provide one or more recommendations to stakeholders.

The method and system of the present disclosure may be employed by one or more users. The one or more users may include stakeholders. The stakeholders may be agents of a business entity. The stakeholders may be employees (e.g., managers) or officers of a business entity. By way of example but not limitation, the stakeholder may be a chief financial officer, chief executive officer, chief operating officer, department manager, the like, or any combination thereof. The stakeholders may be tasked with reviewing research, forecasts, and/or recommendations provided by researching and executing personnel. The stakeholders may have the authority to accept or deny the recommendations of the researching and executing personnel. The stakeholders may provide feedback to researching and executing personnel after reviewing their research, forecasts, and/or recommendations. Moreover, multiple stakeholders may communicate amongst each other. The stakeholders may direct researching and executing personnel to amend their research, forecasts, and/or recommendations. The stakeholders may authorize the purchase of commodities.

Researching and executing personnel and stakeholders may be referred to herein, individually, or collectively, as users.

The present disclosure relates to decision-making processes. These decision-making processes may involve the execution of a decision. These decision-making processes may not involve the execution of a decision. Decision-making processes that don’t involve the execution of a decision may be undertaken for investigative purposes.

It is understood by the present disclosure that communications between researching and executing personnel and stakeholders may involve the passage of time. For instance, an email communication with a purchase recommendation from a researching and executing personnel may dwell in an inbox of stakeholders for a period of time before it is viewed. The stakeholders may take a period of time to review the purchasing recommendation and analyze the decision-influencing factors that informed the recommendation. The stakeholders may provide a communication to the researching and executing personnel either authorizing a purchase, sale, or utilization, or directing the researching and executing personnel to amend the decision-influencing factors to arrive at another recommendation. In the case of the latter, a back-and-forth communication between researching and executing personnel and stakeholders may persist for a period of time before a purchase, sale, or utilization is finally authorized. While this is taking place, the commodity marketplace may shift (e.g., prices may increase or decrease, news affecting current and future prices may be published, or the like) and undermine the assumptions underlying the initial recommendation. Thus, if the decision analysis and communications take too long (e.g., about 1 day or more, about 2 days or more, about 3 days or more, or even about 4 days or more), the researching and executing personnel may have to start an analysis from the beginning.

It is therefore at least one goal of the present disclosure to provide a system and method that reduces the overall time it takes from the start of a researching and executing personnel’s analysis to the provision of a stakeholder’s authorization. By the present system and method, it may be possible for the time from devising a recommendation to executing a decision to be about 2 days or less, more preferably about 1 day or less, more preferably about 12 hours or less, more preferably about 6 hours or less, or even more preferably about 2 hours or less. This may be achieved, at least in part, by providing a method and system that retrieves decision-influencing factors via a network from third party providers (e.g., online news outlets, online market commentators, price indices, and the like), providing a method and system with integrated tools for devising forecasts and/or simulations, providing a method and system that congregates all decision-influencing factors in a single page or window on a graphical user interface, providing a method and system with integrated communication means, or any combination thereof. In this manner, researching and executing personnel and stakeholders may be relieved from navigating through different pages or windows displayed on a graphical user interface. Thus, all of the information and communication utilized to execute a purchase is provided in a unitary location. Moreover, as will be discussed herein, all decision-influencing factors may be congregated in a single location and stored as an immutable electronic ledger. The immutable electronic ledger may be revisited in the future for evaluating the market conditions present during a span of time in the past.

The method and system of the present disclosure may improve the operation of computing devices relative to conventional methods and systems.

Conventional methods and systems may involve the utilization of multiple software platforms to retrieve market commentary, news, historical prices, and other data; formulate forecasts and/or simulations; provide communications between researching and executing personnel and stakeholders; or any combination thereof. As a result, each individual software platform may tax the processing power of computing devices. By way of example, researching and executing personnel may retrieve market commentary, news, historical prices, and other data from online sources via an internet browser. Researching and executing personnel may employ a data extraction program that scans internet pages for specific data and retrieves that specific data. Researching and executing personnel may utilize Microsoft Excel spreadsheets and/or other similar software platforms for organizing data and/or performing operations on data. Researching and executing personnel and stakeholders may communicate via an email client (e.g., Microsoft Outlook) or instant messaging platform (e.g., Microsoft Teams, Slack, or the like).

Moreover, users employing multiple software platforms of conventional methods and systems may involve the users toggling between different graphical user interfaces (e.g., computer monitors), windows, tabs, or any combination thereof.

Thus, the present method and system may be advantageous to provide a single software platform for retrieving market commentary, news, historical prices, and other data; formulating forecasts and/or simulations; providing communications between researching and executing personnel and stakeholders; or any combination thereof. In this manner, processing power may be reduced relative to the conventional methods discussed above. Moreover, the toggling between different graphical user interfaces (e.g., computer monitors), windows, tabs, or any combination thereof may be mitigated or substantially avoided.

Moreover, conventional methods and systems may involve the storing of data in multiple digital locations (e.g., folders, memory storage media, and the like). Thus, retrieving data at a future date can be difficult and time-consuming. Moreover, the data retrieved at a future date may be commingled with data available after the time of making a decision. That is, such multiple digital locations may be un-sequestered from data known or gathered after the time of making a decision. This post-decision data is contaminated by hindsight. It is also possible by conventional methods that some data may be inadvertently discarded or not stored in the first place. By way of example, human error on the part of a researching and executing personnel may lead to discarding of information (e.g., news articles) that influenced a purchasing decision. By way of another example, information (e.g., a news article) that influenced a purchasing decision may have been reviewed but not downloaded and stored.

Thus, the present method and system advantageously include one or more steps of storing data in a single digital location, thus avoiding the discarding of data informing purchasing decisions and ensuring that any data reviewed is stored. These functions may be performed autonomously.

Autonomously, as referred to herein, may mean without any direction by users. Autonomous functions may be performed by computing devices. Autonomous functions may be performed by processors and/or memory storage media of computing devices. Autonomous functions may be performed in response to a stimulus but without specific direction by users. By way of example, information (e.g., a news article) may be saved as a part of an immutable electronic ledger when a user views the information. In this manner, while the user did not direct the system to save the information, merely viewing the information (i.e., the stimulus) prompts the system to save the information.

Conventional methods may involve the storing of large quantities of data. Data that was not reviewed or did not inform a purchasing decision may be stored. By way of example, researching and executing personnel may download a news article from an online news outlet but not actually review the contents thereof. Extraneous data may be stored. By way of example, an online news outlet page including photographs and/or advertisements may be converted to a text-only file that excludes extraneous photographs and/or advertisements. The photographs and/or advertisements may be considered extraneous because they are not relevant to the purchasing decision process.

Thus, the present method and system may be advantageous to recognize whether data is reviewed by researching and executing personnel and/or stakeholders, exclude and/or discard extraneous data, or both. In this manner, the quantity of data may be reduced relative to conventional methods. The benefits realized by the present method and system may include, at least in part, reducing the electronic storage space in which the data occupies, decreasing the effect of bandwidth limitations on downloading and uploading the data, or both.

Conventional methods may utilize record retention by manual techniques. That is, records may be manually generated, assembled, organized, and saved. During such manual techniques, time elapses during which shifts may occur in the market of commodities.

Thus, the present method and system may be advantageous to save records autonomously and substantially contemporaneous with their generation. In effect, the time it would have taken to generate, assemble, organize, and save the records may be mitigated or substantially avoided.

The method and system of the present disclosure may be advantageous to capture only data available to users contemporaneously with the evaluation of a decision. Data of the present disclosure may be stored as a part of an immutable electronic ledger and identified by a date and time of storage. Data available to users contemporaneously with the evaluation of a decision may be sequestered in the immutable electronic ledger. By employing time and date stamping, and/or blockchain technology, as discussed herein, the commingling of data not available to users contemporaneously with the evaluation of a decision may be prevented.

By way of illustration, during a review of a decision evaluation at some point in the future, it may be questioned what information was known and at what time it was known. Thus, the employment of time stamping and/or blockchain technology provides an immutable record of what was known and at what time it was known. The immutable record thus reflects only the actual knowledge of those users involved in the decision evaluation.

### Data

The system of the present disclosure may perform operations upon, store, receive, or transmit data, or any combination thereof. The data may be employed for performing the method of the present disclosure. The data may be input, manipulated, and/or viewed by users. The data may be received from one or more third parties via a network. The data may be transmitted, via a network, to one or more memory storage media. The data may be stored in the immutable electronic ledger of the present disclosure.

The data may comprise historic price data, market commentary, news, price forecasts, simulated purchases, simulated sales, simulated utilizations, schedules, premiums, discounts, labor data, currency exchange rates, inflation rates, logistical costs, or any combination thereof. These types of data may be individually or collectively referred to herein as decision-influencing factors.

The present disclosure contemplates the retrieval, comparison, and/or employment of decision-influencing factors from multiple third-party sources. By way of example, researching and executing personnel may obtain a price forecast report from a first source and a price forecast report from a second source.

A single purchasing decision may involve data associated with different commodities. That is, while a business entity may be interested in purchasing one commodity, they may also be interested in comparing that data with data of other commodities. The other commodities may be similar to the one commodity. The other commodities may be substituted for the one commodity. By way of example, if the business entity believes the price of one commodity is too high, they may look to other alternative commodities that may be purchased at lower prices. By way of another example, two or more commodities may be necessary for the provision of a product and/or service (e.g., multiple chemical components in a blended product).

The historic price data may include actual prices of a commodity at present time and in the past. The historic price data may be provided for a period of time in the past. The period of time may be about 1 day or more, 1 week or more, 1 month or more, 6 months or more, 1 year or more, or even 3 years or more. The period of time may be about 10 years or less, 8 years or less, 6 years or less, or even 4 years or less.

The historic price data may originate from one or more commodity exchanges.

Historic price data may be presented in a graphical or tabular format. Graphical formats may include line graphs, candlestick graphs, or both. Users may toggle between different visual formats. Users may toggle between different periods of time. By way of example, a user may choose to view historic price data for 6 months in the past or 3 months in the past.

The market commentary may include any commentary or analysis of the market. The commentary or analysis may be authored and/or published by third parties. The third parties may include financial analysts, financial institutions, the like, or any combination thereof. The market commentary may provide insight into current events’ effect on the market. The market commentary may provide a summary of mathematical or statistical analysis on market data. The market commentary may interpret trends in the market.

The market commentary may include price forecast reports and/or forward price curves. Price forecast reports may tabulate forecasted prices on a periodic basis for different types of commodities. These reports may be authored by analysts. The forward price curve may graph forecasted prices over time. Forward price curves may represent current pricing of a commodity futures contract. While price forecast reports and/or forward price curves may provide researching and executing personnel with the data for a price forecast, as discussed herein, researching and executing personnel may modify these data sources with their own knowledge to arrive at their own price forecasts.

The market commentary may include supply and demand analyses. The supply and demand analyses may characterize how much commodity suppliers are willing to sell commodities at different prices, how much consumers are willing to buy at different prices, or both.

The news may include any articles published by news outlets. The articles may include reports on current events, reports on market trends, reports summarizing market commentary, opinion reports, the like, or any combination thereof. Exemplary news outlets may include but are not limited to CNBC, Wall Street Journal, Forbes, Reuters, the like, or any combination thereof.

The price forecast may include forecasted prices at one or more future dates. That is, what an individual believes the price of a commodity will be. The one or more future dates may be within a time period of about 1 month or more, 2 months or more, 3 months or more, or even 4 months or more. The one or more future dates may be within a time period of about 2 years or less, 1 year or less, or even 6 months or less. The price forecast may be defined at intervals of time. The intervals of time may include weeks, months, fiscal quarters, years, or any combination thereof. By way of example, a price may be forecast for fiscal quarter 1, another price may be forecast for fiscal quarter 2, and so on.

The price forecast may reflect what researching and executing personnel believe the price will be in the future. The price forecast may be informed by historical price data, market commentary, news, labor data, currency exchange rates, inflation rates, the like, or any combination thereof. The price forecast may be informed by researching and executing personnel’s own analytical tools. By way of example, researching and executing personnel may employ one or more algorithms by which future prices may be forecasted.

The simulated purchases may include one or more quantities of a commodity purchased or considered to be purchased at one or more future dates, at one or more forecasted prices. The quantities, dates, and/or forecasted prices may be populatable fields. The populatable fields may be displayed on a graphical user interface. Users may input data into the populatable fields via one or more user interfaces.

The simulated purchases may assist users to determine price outcome for a commodity and/or product over a period of time. By way of example, if a user simulates a first purchase of 1,000 units of a commodity at a forecasted price of $100 and a second purchase of 500 units of a commodity at a forecasted price of $120, then the user may determine that the price outcome for the commodity will amount to $160,000, which is to be paid by the business entity upon purchase.

The simulated sales may include a quantity of the commodity to be sold or considered to be sold by the business entity at a future date at a forecasted price. The quantities, dates, and/or forecasted prices may be populatable fields. The populatable fields may be displayed on a graphical user interface. Users may input data into the populatable fields via one or more user interfaces.

The simulated sales may assist users to determine a price outcome for a commodity and/or product over a period of time. By way of example, if a user simulates a first sale of 1,000 units of a commodity at a forecasted price of $100 and a second sale of 500 units of a commodity at a forecasted price of $120, then the user may determine that the price outcome for the commodity will amount to $160,000, which is to be collected by the business entity upon sale.

The simulated utilizations may include a quantity of the commodity and/or product to be utilized or considered to be utilized by the business entity to produce a quantity of products or other products at a future date. The quantities and/or dates may be populatable fields. The populatable fields may be displayed on a graphical user interface. Users may input data into the populatable fields via one or more user interfaces.

The simulated utilizations may assist users to determine the quantity of commodities and/or products that will be consumed at one or more future dates. By way of example, if a production schedule requires that 200 kilograms of brass are to be produced by a specified date and the brass is comprised of 65% copper and 35% zinc, then by the specified date, 130 kilograms of copper will be consumed and 70 kilograms of zinc will be consumed.

Simulated purchases, simulated sales, and/or simulated utilizations may be compared to actual sales, actual purchases, and/or actual utilizations. Actual sales, actual purchases, and/or actual utilizations may have been actually commenced. By such comparison, users may determine the accuracy of the simulations.

The schedules may include purchasing schedules, commodity receipt schedules, production schedules, shipping schedules, or any combination thereof. The schedules may inform when commodities and/or products are planned to be purchased. The schedules may inform when certain quantities of commodities are required by the business entity.

Premiums may refer to contract premiums for purchasing commodities and/or products. Typically, premiums are costs associated with entering into purchasing contracts.

Discounts may refer to any discounts associated with the purchasing or selling of commodities and/or products. By way of example, a business entity may offer customers a discount based upon the quantity of commodities and/or products they are purchasing from the business entity.

Logistical costs may refer to the costs of transporting commodities from their origin to their destination. Logistical costs may be charged by common carriers. Logistical costs may include landing costs, fuel costs, loading costs, unloading costs, transport vehicle costs, the like, or any combination thereof.

Labor data may refer to employment rates, employee earnings, and the like. Labor data may be obtained from third party sources. The third-party sources may include, but are not limited to, government agencies (e.g., U.S. Bureau of Labor Statistics).

Currency exchange rates may refer to the rate at which one currency is converted to another. Currency exchange rates may be obtained from third party sources. The third-party sources may include, but are not limited to, government agencies (e.g., U.S. Department of the Treasury).

Inflation rates may refer to the rate of increase in the prices within an economy. Inflation rates may be obtained from third party sources. The third-party sources may include, but are not limited to, government agencies (e.g., U.S. Department of Labor).

Advantageously, the present disclosure realizes a method and system that presents data in a format that is succinct and easy to view and understand. The data may be presented in a format that is widely understood among researching and executing personnel and stakeholders. Thus, researching and executing personnel and stakeholders without advanced financial or market knowledge may be able to view and understand the data presented to them in order to guide them in their decision-making process. Moreover, the time it takes to review and understand the information presented may be reduced relative to conventional methods and systems.

The data of the present disclosure, or at least a portion thereof, may be stored as one or more immutable electronic ledgers (“ledgers”). The immutable electronic ledger may serve as a record of decision-influencing factors for a business entity executing purchases of commodities.

The electronic ledger may be immutable. Immutable, as referred to herein, may mean un-editable except perhaps by a system administrator with appropriate permissions. It may be particularly advantageous for the electronic ledger to be immutable to avoid the loss or altering of data.

Researching and executing personnel’s decisions are generally under a great deal of scrutiny due to the costs associated with purchasing decisions. Thus, a ledger may be advantageous to record decision-influencing factors to allow for review at a future date. The ledger may be utilized to learn from past decisions and address any problems with the decision-making process.

The ledger may capture only data available to users contemporaneously with the evaluation of a decision. Data of the present disclosure may be stored as a part of the immutable electronic ledger and identified by a date and time of storage. Data available to users contemporaneously with the evaluation of a decision may be sequestered in the immutable electronic ledger. By employing time and date stamping, and/or blockchain technology, as discussed herein, the commingling of data not available to users contemporaneously with the evaluation of a decision may be prevented.

The ledger may be stored on one or more memory storage media. Preferably, the ledger may be stored on one memory storage medium. The memory storage medium may be local to or remote from one or more computing devices. The memory storage medium may be located in a cloud server (“cloud-based”). The memory storage medium may be located on a computing device of the business entity.

The immutable electronic ledger may be centralized, such that a central authority controls the data stored in the immutable electronic ledger.

The ledger may utilize blockchain technology. The blockchain may include a chain of block data structures. Each block may be identified by a block hash. As blocks are added to the data structure, new blocks may reference the block hash of the prior block. Thus, any break in the continuity of pre-referential block hashes may indicate that a block has been altered. Each block may include data. The data may include decision-influencing factors, or any other data or information discussed herein. As the ledger is populated with decision-influencing factors, the decision-influencing factors may be added as a block to the blockchain.

The ledger may include all decision-influencing factors utilized by researching and executing personnel and/or stakeholders. The ledger may be updated in real-time. Each update to the ledger may be time-stamped. The time stamp may include a date and/or time. Each update to the ledger may be identified by the individual researching and executing personnel or stakeholder who initiated the update. The ledger may be updated to include historical price data at any time it is accessed or updated by researching and executing personnel and/or stakeholders. The ledger may be updated to include market commentary and/or news at any time they are accessed or viewed by researching and executing personnel and/or stakeholders. The ledger may be updated to include any other data or information discussed herein at any time they are accessed or viewed by researching and executing personnel and/or stakeholders. The ledger may be updated to include forecast prices any time they are established and updated by researching and executing personnel and/or stakeholders. The ledger may be updated to include simulated purchases, simulated sales, and/or simulated utilizations any time they are established or updated by researching and executing personnel and/or stakeholders. The ledger may be updated to include communications any time they are transmitted between researching and executing personnel and stakeholders. The ledger may be updated autonomously. The ledger may be updated autonomously in response to a stimulus. An example of a stimulus may include, without limitation, accessing data or information (e.g., decision-influencing factors).

The ledger may be viewable on a graphical user interface. The ledger may be viewable as a unitary page on a graphical user interface. The ledger may be organized chronologically. That is, data may be displayed on a graphical user interface chronologically in the order by which they were added to the ledger. The ledger may be organized by category. That is, data may be organized by historical price data, market commentary, news, forecast prices, simulated purchases, simulated sales, simulated utilizations, by type of data or information, or any combination thereof. The ledger may be organized both by category and chronologically within each category.

The system of the present disclosure may communicate with an enterprise resource planning software (“ERP”). The ERP may manage a business entity’s financials, supply chain, operations, commerce, reporting, manufacturing activities, or any combination thereof. The ERP may comprise data that may inform the decision-making process. By way of example, the ERP may include a current inventory of commodities, which may inform when new inventory must be received.

Computing devices may communicate with an ERP via an API. Computing devices may communicate with an ERP via a network. Computing devices may receive data from an ERP, transmit data to an ERP, or both. Data retrieved from an ERP may be stored as a part of the immutable electronic ledger.

The system of the present disclosure may evaluate correlations between purchasing decisions that are a part of the ledger. Correlations between purchasing decisions regarding the same commodity or even similar commodities may inform future decisions. By way of example, if current market conditions are similar to those existing during a past decision, this correlation may inform researching and executing personnel and/or stakeholders that they may consider executing another purchase or multiple purchases. The system may autonomously devise decision suggestions. The system may transmit alerts to researching and executing personnel and/or stakeholders upon devising decision suggestions. The system may employ a neural network for this functionality.

### System

The system of the present disclosure may comprise one or more computing devices. The computing devices may function to receive and/or transmit data, perform operations with data, store data, retrieve data, execute computer-readable instructions, or any combination thereof. The computing devices may be one or more personal computers, mobile devices, or both. The personal computers may be a laptop computer, desktop computer, or both. The mobile devices may be a tablet, mobile phone, smart watch, the like, or any combination thereof.

The computing devices may include or communicate with one or more other computing devices, processors, memory storage media, network modules, databases, user interfaces, or any combination thereof. The computing devices may communicate via a wired connection, wireless connection, or both. The processors, memory storage media, network modules, databases, user interfaces, or any combination thereof may be local to and/or remote from the computing devices. The computing devices may communicate via a network. The computing devices may communicate via an interaction interface. The interaction interface may be an application programming interface (“API”).

The computing devices may include one or more processors, memory storage media, databases, network modules, user interfaces, or any combination thereof.

The system of the present disclosure may comprise one or more processors. The processors may function to retrieve data, receive data, perform one or more operations with data, transmit data, or any combination thereof.

The one or more operations may include executing one or more computer-readable instructions, executing one or more algorithms, applying one or more rules, or any combination thereof. The processor may retrieve and/or receive computer-readable instructions, algorithms, rules, or any combination thereof from memory storage media. The processor may retrieve and/or receive data from one or more memory storage medium (input), perform operations with the data (processing), and transmit processed data to one or more memory storage media (output).

The processors may be one or more central processing units (“CPU”), graphics processing units (“GPU”), field-programmable gate arrays (“FPGA”), or any combination thereof. An example of a suitable CPU may include the Intel® CoreTM i9-10900K, incorporated herein by reference in its entirety for all purposes. An example of a suitable GPU may include the NVIDIA GeForce RTXTM 3090, incorporated herein by reference in its entirety for all purposes.

The processors may be local to (on-board) computing devices. The processors may be remote from computing devices. The processors may communicate with other processors, memory storage media, network modules, or any combination thereof.

The processors may include one or more cloud-based processors. The cloud-based processors may be located remote from computing devices. The cloud-based processors may be accessible via one or more networks. An example of a suitable cloud-based processor may include the Amazon Elastic Compute Cloud™ (EC2TM) provided by Amazon Web Services®, incorporated herein by reference in its entirety for all purposes. Another example of a suitable cloud-based processor may include Lambda™ provided by Amazon Web Services®, incorporated herein by reference in its entirety for all purposes.

The system of the present disclosure may comprise one or more memory storage media. The memory storage media may function to store one or more applications, data, databases, computer-readable instructions, algorithms, rules, the like, or any combination thereof. The memory storage media may be non-transitory memory storage media.

The data stored within the memory storage media may be compressed, encrypted, or both. The memory storage media may store data in a native format, foreign format, or both. The memory storage media may store data as one or more databases. The memory storage media may store data as objects, files, blocks, or any combination thereof.

The memory storage media may cooperate with one or more processors for accessing, executing, and/or storing one or more applications, data, databases, algorithms, rules, computer-readable instructions, the like, or any combination thereof.

The memory storage media may include one or more hard drives, chips, discs, flash drives, memory cards, the like, or any combination thereof. The hard drives may include a solid-state disk (“SSD”), hard drive disk (“HDD”), the like, or any combination thereof. The chips may hold memory temporarily via random access memory (“RAM”), permanently via read only memory (“ROM”), or both. The chips may include dynamic random access memory (“DRAM”) chips, static random access memory (“SRAM”) chips, first in first out (“FIFO”) chips, erasable programmable read only memory (“EPROM”), programmable read only memory (“PROM”), the like, or any combination thereof. The discs may include floppy diskettes, hard disk drives, optical data storage media (e.g., CD ROMs, DVDs), the like, or any combination thereof.

The memory storage media may be local to computing devices. The memory storage media may be remote from computing devices.

The memory storage media may include cloud-based memory storage media. The cloud-based memory storage media may be located remote from computing devices. The cloud-based memory storage media may be accessible via one or more networks. An example of a suitable cloud-based memory storage media may include Amazon S3™ provided by Amazon Web Services®, incorporated herein by reference in its entirety for all purposes.

The system of the present disclosure may comprise one or more databases. The databases may function to receive data, organize data, or both. The databases may be stored on memory storage media. The databases may be accessible by one or more processors to retrieve data for performing one or more operations with the data. Processed data may be provided to databases by one or more processors for storage.

The databases may include any type of database suitable for storing data. The data may be stored within databases in any suitable storage form using any suitable database management system (“DBMS”). Exemplary storage forms may include relational databases, non-relational databases, correlation databases, ordered/unordered flat files, structured files, the like, or any combination thereof. The relational databases may include SQL database, row-oriented, column-oriented, the like, or any combination thereof. The non-relational databases may include NoSQL database.

The databases may store one or more classifications of data models. The classifications may include column (e.g., wide column), document, key-value (e.g., key-value cache, key-value store), object, graph, multi-model, the like, or any combination thereof.

The databases may be stored on memory storage media local to computing devices. The databases may be stored on memory storage media remote from computing devices. The databases may include cloud-based databases. The cloud-based databases may be located remote from computing devices. The cloud-based databases may be accessible via one or more networks. An example of a suitable cloud-based database may include Amazon DynamoDB® offered through Amazon Web Services®, incorporated herein by reference in its entirety for all purposes.

The system of the present disclosure may comprise one or more user interfaces. The user interfaces may function to display data in a visual format, receive user inputs, transmit data associated with the user inputs, or any combination thereof.

The user interfaces may include one or more cameras, graphical user interfaces (“GUI”), microphones, speakers, keyboards (e.g., physical keyboard, digital keyboard, or both), mice, the like, or any combination thereof. The user interface may be on-board a computing device (e.g., a mobile phone screen), remote from a computing device (e.g., a separate peripheral computer monitor), or both.

User interfaces that receive user inputs may be referred to as input devices. The input devices may function to receive one or more user inputs from a user, convert user inputs into signals, or both. The input devices may include one or more buttons, wheels, keyboards, switches, mice, joysticks, touch pads, touch-sensitive screens, microphones, the like, or any combination thereof.

The touch pad may include a touch-sensitive area, provided as a separate peripheral or integrated into a computing device, which does not display visual output. The touch-sensitive screens may function to accept user inputs from a user based on tactile contact. The touch-sensitive screens may include a screen, display controller, or both. The touch-sensitive screens may detect contact and convert the detected contact into interaction with one or more interface objects (e.g., buttons, icons, web pages, images, menus, the like, or any combination thereof) that are displayed on the touch-sensitive screen. The touch-sensitive screens may detect contact via touch sensing technology. The touch sensing technology may include capacitive, resistive, infrared, surface acoustic wave technologies, or any combination thereof. The touch-sensitive screens may detect contact from an appendage (e.g., finger), an object (e.g., a stylus), or both.

The user interfaces may include one or more graphical user interfaces (“GUI”). The graphical user interfaces may include one or more screens. The screens may be located on a computing device, remote from a computing device, or both. An example of a screen located on a computing device may include a mobile phone screen. An example of a screen located remote from a computing device may include an external monitor for a desktop computer.

The screens may utilize liquid crystal display (“LCD”) technology, light emitting polymer display (“LPD”) technology, light emitting diode (“LED”) technology, organic light emitting diode (OLED) technology, the like, or any combination thereof.

The graphical user interfaces may be in communication with user input devices. The input devices may be integrated with the graphical user interfaces. The input devices may include one or more touch-sensitive screens.

The graphical user interfaces may display one or more interface metaphors (i.e., “interface objects”). The interface metaphor may function to give the user instantaneous knowledge about how to interact with the user interface. The interface metaphor may include visuals, actions, and procedures that exploit specific knowledge that users may already possess from other domains of life. An example of an interface metaphor may include a file folder icon, which a user generally intuitively knows to contain one or more individual files. Another example of an interface metaphor may include one or more menus (e.g., drop-down menus), which a user generally intuitively knows to list functions that may be selected. Another example of an interface metaphor may include a button displayed on a touch-sensitive monitor screen, which a user generally intuitively knows that upon pressing a button, an associated function may be initiated.

The system of the present disclosure may comprise one or more networks. The networks may function to transmit data between computing devices.

The networks may be formed by placing two or more computing devices in communication with one another. The networks may be temporarily and/or permanently connected to computing devices. The computing devices may be in selective communication with the networks. The networks may allow for computing devices to be connected to other computing devices to transmit data, receive data, or both. The networks may allow for computing devices to transmit data to or receive data from memory storage media, or both. The networks may allow for transmission of data for processing by processors. The networks may be connected to other networks.

The networks may include one or more local area networks (“LAN”), wide area networks (“WAN”), virtual private network (“VPN”), personal area networks (“PAN”), cellular networks, Bluetooth® networks, intranet, internet, the like, or any combination thereof. The networks may include a wireless network, wired network, or both.

The system of the present disclosure may comprise one or more network modules. The network modules may receive data from and/or transmit data to computing devices, integrate computing devices into a network, or both.

The network modules may communicate with other network modules via a network. The network modules may provide for communication between computing devices.

The network modules may include wired network modules, wireless network modules, or both. A wired network module may be any module capable of transmitting and/or receiving data via a wired connection. The wired network module may communicate with networks via a direct, wired connection. The wired network module may include a network interface controller, PC Card, PCMCIA card, PCI card, the like, or any combination thereof. The wired connection may include an ethernet port. The wireless network module may include any module capable of transmitting and/or receiving data via a wireless connection. The wireless network modules may communicate with one or more networks via a wireless connection. The one or more wireless network modules may include a cellular transceiver, Wi-Fi transceiver, Bluetooth® transceiver, infrared transceiver, radio frequency transceiver, near-field communication (“NFC”) module, the like, or any combination thereof.

### Method

The method may comprise one or more of the following steps. Some of the steps may be duplicated, removed, rearranged relative to other steps, combined into one or more steps, separated into two or more steps, or a combination thereof.

While some of the following steps may be recited together, this does not indicate that it is essential that the steps be performed together. Many combinations of the following steps are contemplated by the present disclosure, as will be appreciated by the following description. The Applicant does not intend to be bound by any chronology or grouping of the following steps.

The method of the present disclosure may comprise receiving, by one or more computing devices, one or more decision-influencing factors relating to a price of one or more commodities. The one or more decision-influencing factors may include one or more price forecasts, simulated purchases, simulated sales, simulated utilizations, historical price data, market commentary, news, labor data, currency exchange rates, inflation rates, logistical costs, schedules, premiums, discounts, or any combination thereof.

The method may comprise autonomously storing, by one or more memory storage media, the one or more decision-influencing factors as a part of the immutable electronic ledger. Storage as a part of the immutable electronic ledger may autonomously occur upon initial receipt by the one or more computing devices, access by the one or more users, or any change effectuated by the one or more users. Instead of autonomously storing, the storing occurs at the direction of the one or more users. The immutable electronic ledger may serve as a record of decision-influencing factors for a business entity in an evaluation of a decision influenced by a price of the one or more commodities. The immutable electronic ledger may be free of hindsight. That is, the immutable electronic ledger may be free of data that was made available after the time of the evaluation of the decision.

The method may be employed in the decision to purchase one or more commodities. The one or more decision-influencing factors may relate to a purchasing decision. Business entities typically seek to purchase commodities at a favorable price. The decision-influencing factors may assist in the forecast of prices of commodities in the future. Based on price forecasts, business entities may determine the quantity and/or timing of purchases to align with favorable prices. Based on price forecasts, business entities may determine to purchase alternative and/or similar commodities. The alternative and/or similar commodities may be substituted for commodities previously employed to produce products. The alternative and/or similar commodities may be purchased at prices more favorable than commodities previously employed to produce products. By way of example, a business entity previously using 1018 grade carbon steel may find that 1020 grade carbon steel can be substituted and for a lower price.

The method may be employed in the decision to sell one or more commodities. The method may be employed in the decision to price one or more products produced from one or more commodities for sale. The one or more decision-influencing factors may relate to a sales decision. Business entities typically seek to price products commensurate with the price of the raw materials used to produce the products. The decision-influencing factors may assist in the forecast of prices of commodities in the future. Based upon price forecasts, business entities may determine the prices to set upon products.

The method may be employed in the decision to set an inventory policy and/or sales policy of one or more commodities.

The inventory policy may include a quantity of commodity inventory maintained in-house at any given time, the timing and/or frequency of replenishing commodity inventory, the minimum commodity inventory quantity maintained in-house at any given time, the maximum commodity inventory quantity maintained in-house at any given time, or any combination thereof.

The sales policy may include a quantity of products maintained in-house at any given time, the timing and/or frequency of selling products, the maximum product quantity maintained in-house at any given time, the minimum product quantity maintained in-house at any given time, or any combination thereof.

The method may comprise transmitting, by one or more first computing devices of one or more first users (e.g., researching and executing personnel), one or more decision-influencing factors to one or more second computing devices of one or more second users (e.g., stakeholders). The one or more communications may be transmitted via a network. The one or more decision-influencing factors may be transmitted to the one or more second users to review. The one or more decision-influencing factors may be transmitted to the one or more second users to elicit approval to take an action or instruction to refrain from taking an action. The action may include selling commodities, purchasing commodities, producing products from commodities. The one or more first users and the one or more second users may communicate back-and-forth in determining to take or refrain from taking an action.

The method may comprise receiving, by the one or more first computing devices via the network, one or more communications from the one or more second computing devices. The method may comprise autonomously storing, by the one or more memory storage media, the one or more communications between the one or more first computing devices and/or the one or more second computing devices as a part of the immutable electronic ledger identified by a date and time of storage.

The method may comprise receiving, by the one or more second computing devices via the network, one or more communications from the one or more first computing devices. The method may comprise autonomously storing, by the one or more memory storage media, the one or more communications between the one or more first computing devices and/or the one or more second computing devices as a part of the immutable electronic ledger identified by a date and time of storage.

The method may comprise displaying, by a graphical user interface, contents of the immutable electronic ledger relating to the evaluation of the decision. The contents of the immutable electronic ledger may include only data available contemporaneously with the evaluation of the decision.

The decision-influencing factor receiving step may be performed by extracting, by the one or more computing devices, decision-influencing factor data from one or more third party sources. The one or more third party sources may be accessible by the one or more computing devices via a network. The one or more third party sources may be network-accessible websites of publishers of market data.

The receiving steps may be performed by one or more user interfaces of the one or more computing devices.

The immutable electronic ledger may be centralized, such that a central authority controls the data stored in the immutable electronic ledger.

The immutable electronic ledger may be stored on a single memory storage medium. The one or more memory storage media may be hardware local to the one or more computing devices, located in a cloud server, or both. The one or more memory storage media may be located on a computing device of the business entity.

The method of the present disclosure may comprise storing data as a part of an immutable electronic ledger. The immutable electronic ledger may serve as a record of decision-influencing factors for a business entity. The business entity may be evaluating a decision influenced by a price of one or more commodities. The immutable electronic ledger may be free of hindsight. That is, the immutable electronic ledger may be free of data that was made available after the time of the evaluation of the decision.

The method may comprise receiving, by one or more computing devices, one or more price forecasts of one or more commodities. The one or more price forecasts may be received from one or more users and/or one or more third party sources. The one or more price forecasts may be received by a user interface of the one or more computing devices. That is, users may input data via the user interface. The one or more users may be researching and executing personnel and/or stakeholders.

The one or more price forecasts may be extracted from one or more third party sources. The third party sources may be accessible by one or more computing devices via a network. The third-party sources may be network-accessible websites of publishers of market data. By way of example, the third-party source may publish a forward price curve that can be extracted via data extraction techniques and the data may be input as the price forecast.

The method may comprise storing, by one or more memory storage media, the one or more price forecasts. The one or more price forecasts may be stored as a part of the immutable electronic ledger. The one or more price forecasts may be identified by a date and time of storage. The storing may be performed autonomously. Storage as a part of the immutable electronic ledger may occur autonomously upon initial receipt by the user interface, access by users, or any change effectuated by users. Storage as a part of the immutable electronic ledger may occur at the direction of users.

The method may comprise assigning, by one or more processors, a block hash to the one or more price forecasts. The assigning may be performed autonomously. The method may comprise autonomously storing, by one or more memory storage media, the one or more price forecasts as a block of a blockchain.

The method may comprise displaying, by a user interface, one or more populatable fields. Users may be prompted to input data into the populatable fields. The method may comprise storing, by one or more memory storage media, data entered into the populatable fields. Storage may occur autonomously as the populatable fields are populated. Storage may occur autonomously as users interact with the user interface. The populatable fields may provide users with a decision-making framework.

The populatable fields may include quantities of commodities and/or products, prices of commodities and/or products, dates of simulated purchase, dates of simulated sales, dates of simulated utilizations, premiums, discounts, logistical costs, the like, or any combination thereof. Populating some populatable fields may cause other populatable fields to be populated. This may be performed autonomously. By way of example, prices of commodities at one or more future dates input into one of the price forecasts may cause prices of commodities in a simulated purchase, sale, and/or utilization to be populated.

The method may comprise displaying, by a user interface, headlines to market commentary and/or news. The headlines may include embedded hyperlinks. The method may comprise storing, by one or more memory storage media, market commentary and/or news. Storage may be performed autonomously upon access by users. For example, a user may access a news article by clicking on the hyperlink of the headline. Storage may occur autonomously as users interact with the user interface.

The market commentary and/or news may be extracted from one or more third party sources. The third-party sources may be accessible by one or more computing devices via a network. The third-party sources may be network-accessible websites of publishers of market data. The data extracted may include headlines, abstracts, text, figures, graphs, authors, publishing dates, the like, or any combination thereof.

The method may comprise receiving, by one or more first computing devices, one or more simulated purchases, one or more simulated sales, one or more simulated utilizations, or any combination thereof from one or more users. The users may be researching and executing personnel. The data of one or more simulated purchases, one or more simulated sales, one or more simulated utilizations, or any combination thereof may be received by a user interface of the one or more first computing devices. That is, users may input data via the user interface.

The method may comprise storing, by one or more memory storage media, the one or more simulated purchases, one or more simulated sales, one or more simulated utilizations, or any combination thereof. The one or more simulated purchases, one or more simulated sales, one or more simulated utilizations, or any combination thereof may be stored as a part of the immutable electronic ledger. The one or more simulated purchases, one or more simulated sales, one or more simulated utilizations, or any combination thereof may be identified by a date and time of storage. The storage may be performed autonomously. Storage as a part of the immutable electronic ledger may occur autonomously upon initial receipt by the user interface, access by the users, or any change effectuated by the users. Storage as a part of the immutable electronic ledger may occur at the direction of the first user.

The method may comprise assigning, by one or more processors, a block hash to the one or more simulated purchases, one or more simulated sales, one or more simulated utilizations, or any combination thereof. The assigning may be performed autonomously. The method may comprise storing, by one or more memory storage media, the one or more simulated purchases, one or more simulated sales, one or more simulated utilizations, or any combination thereof as a block of a blockchain. The storing may be performed autonomously.

The method may comprise repeating, for one or more iterations, the step of receiving the one or more price forecasts of one or more commodities. In other words, users may update the price forecast. The price forecast may be updated to arrive at a more accurate price forecast. The price forecast may be updated to provide different scenarios, which may be compared to one another.

The method may comprise repeating, for one or more iterations, the step of receiving the one or more simulated purchases, the one or more simulated sales, the one or more simulated utilizations, or any combination thereof. In other words, users may update the one or more simulated purchases, the one or more simulated sales, the one or more simulated utilizations, or any combination thereof. The one or more simulated purchases, the one or more simulated sales, the one or more simulated utilizations, or any combination thereof may be updated to arrive at a desired price outcome. The one or more simulated purchases, the one or more simulated sales, the one or more simulated utilizations, or any combination thereof may be updated to provide different scenarios, which may be compared to one another.

The method may comprise receiving, by one or more computing devices, a designation of each scenario as a best-case scenario, a worst-case scenario, or a most probable scenario. The designation may be received by a user interface. That is, users may input the designations via the user interface.

The method may comprise storing, by one or more memory storage media, the designation. The designation may be stored as a part of the immutable electronic ledger. The designations may be identified by a date and time of storage. The storing may be performed autonomously.

The method may comprise calculating, by one or more computing devices, a price outcome of one or more simulated purchases, one or more simulated sales, one or more simulated utilizations, or any combination thereof. The calculation may be based upon the one or more price forecasts. By way of example, a price of a commodity at a future date may be multiplied by a quantity of the commodity that may be purchased at that future date (simulated purchase) to arrive at the price outcome. The calculation may be performed by one or more processors of the one or more computing devices. Calculation may occur autonomously upon initial receipt by the user interface, access by users, or any change effectuated by users. Calculation may occur at the direction of users.

The method may comprise storing, by one or more memory storage media, the price outcome. The price outcome may be stored as a part of the immutable electronic ledger. The price outcome may be identified by a date and time of storage. Storage as a part of the immutable electronic ledger may occur autonomously upon calculation. Storage as a part of the immutable electronic ledger may occur at the direction of one or more users.

The method may comprise assigning, by one or more processors, a block hash to the price outcome. The assigning may be performed autonomously. The method may comprise storing, by one or more memory storage media, the price outcome as a block of a blockchain. The storing may be performed autonomously.

The method may comprise receiving, by one or more computing devices via a network, historical price data. The historical price data may be input by users. The historical price data may be extracted, by one or more computing devices, from one or more third party sources. The third-party sources may be accessible by the computing devices via a network. The third-party sources may be network-accessible websites of publishers of market data.

The method may comprise storing, by one or more memory storage media, the historical price data. The historical price data may be stored as a part of the immutable electronic ledger. The historical price data may be identified by a date and time of storage. The storing may be performed autonomously. Storage as a part of the immutable electronic ledger may occur autonomously upon initial receipt by the user interface, access by users, or any change effectuated by users. Storage as a part of the immutable electronic ledger may occur at the direction of users.

The method may comprise assigning, by one or more processors, a block hash to the historical price data. The assigning may be performed autonomously. The method may comprise storing, by one or more memory storage media, the historical price data as a block of a blockchain. The storing may be performed autonomously.

The method may comprise receiving, by one or more computing devices via a network, market commentary and/or news. The market commentary and/or news may be input by users. The market commentary and/or news may be extracted, by one or more computing devices, from one or more third party sources. The third-party sources may be accessible by the computing devices via a network. The third-party sources may be network-accessible websites of publishers of market data.

The method may comprise storing, by one or more memory storage media, the market commentary and/or the news. The market commentary and/or news may be stored as a part of the immutable electronic ledger. The market commentary and/or the news may be identified by a date and time of storage. The storing may be performed autonomously. Storage as a part of the immutable electronic ledger may occur autonomously upon initial receipt by the user interface, access by users, or any change effectuated by users. Storage as a part of the immutable electronic ledger may occur at the direction of users.

The method may comprise assigning, by one or more processors, a block hash to the market commentary and/or news. The assigning may be performed autonomously. The method may comprise storing, by one or more memory storage media, the market commentary and/or news as a block of a blockchain. The storing may be performed autonomously.

The method may comprise receiving, by one or more computing devices, labor data, currency exchange rates, inflation rates, logistical costs, schedules, premiums, discounts, or any combination thereof. This data may be input by users. This data may be extracted, by one or more computing devices, from one or more third party sources. The third-party sources may be accessible by the computing devices via a network. The third-party sources may be network-accessible websites of publishers of market data.

The method may comprise storing, by one or more memory storage media, labor data, currency exchange rates, inflation rates, logistical costs, schedules, premiums, discounts, or any combination thereof. This data may be stored as a part of the immutable electronic ledger. The labor data, currency exchange rates, inflation rates, logistical costs, schedules, premiums, discounts, or any combination thereof may be identified by a date and time of storage. The storing may be performed autonomously. Storage as a part of the immutable electronic ledger may occur autonomously upon initial receipt by the user interface, access by users, or any change effectuated by users. Storage as a part of the immutable electronic ledger may occur at the direction of users.

The method may comprise assigning, by one or more processors, a block hash to the labor data, currency exchange rates, inflation rates, logistical costs, schedules, premiums, discounts, or any combination thereof. The assigning may be performed autonomously. The method may comprise storing, by one or more memory storage media, labor data, currency exchange rates, inflation rates, logistical costs, schedules, premiums, discounts, or any combination thereof as a block of a blockchain. The storing may be performed autonomously.

The method may comprise transmitting, by one or more first computing devices via the network, one or more price forecasts, one or more simulated purchases, one or more simulated sales, one or more simulated utilizations, historical price data, market commentary, news, labor data, currency exchange rates, inflation rates, logistical costs, schedules, premiums, discounts, any other data or information discussed herein, or any combination thereof to one or more second computing devices. The one or more first computing devices may be operated by one or more first users. The first users may be researching and executing personnel. The one or more second computing devices may be operated by one or more second users. The second users may be stakeholders.

The method may comprise receiving, by one or more first computing device via the network, one or more communications from the one or more second computing devices.

The method may comprise receiving, by one or more second computing devices via the network, one or more communications from one or more first computing devices.

The method may comprise storing, by one or more memory storage media, communications between the one or more first computing devices and the one or more second computing devices. The communications may be stored as a part of the immutable electronic ledger. The communications may be identified by a date and time of storage. The storage may be performed autonomously. Storage as a part of the immutable electronic ledger may occur autonomously upon receipt of communications by the user interface or transmittal of communications. Storage as a part of the immutable electronic ledger may occur at the direction of the users.

The method may comprise assigning, by one or more processors, a block hash to communications. The assigning may be performed autonomously. The method may comprise autonomously storing, by one or more memory storage media, communications as a block of a blockchain. The storing may be performed autonomously.

One or any combination of the storage steps of the above method may take place substantially contemporaneously with the inputting, retrieval, access, or viewing of the data and information discussed herein. Substantially contemporaneously may mean no more than 2 hours, more preferably no more than 1 hour, more preferably no more than 30 minutes, even more preferably no more than 1 minute, or even more preferably no more than 1 second.

The method may comprise displaying, by a graphical user interface, contents of the immutable electronic ledger relating to an evaluation of a decision. The contents of the immutable electronic ledger may include only data available contemporaneously with the evaluation of the decision.

The method may comprise displaying, by a graphical user interface, contents of the immutable electronic ledger. The contents may include the one or more price forecasts, the one or more simulated purchases, the one or more simulated sales, the one or more simulated utilizations, any other data and information discussed herein, or any combination thereof. The method may comprise displaying actual historic prices, actual purchases, actual sales, actual utilizations, or any combination thereof. The one or more price forecasts, the one or more simulated purchases, the one or more simulated sales, and/or the one or more simulated utilizations may be compared against actual historic prices, actual purchases, actual sales, actual utilizations, respectively. Such comparison may be performed to determine the accuracy of the forecasts and/or simulations.

The method may comprise displaying, by a graphical user interface, an overlay of two or more price forecasts. The two or more price forecasts may be provided for different scenarios related to different decision evaluations over time. By way of example, a price forecast generated in fiscal quarter 1 can be compared to a price forecast generated in fiscal quarter 4.

The two or more price forecasts may be provided for different scenarios related to the same and/or different commodities. By way of example, a price forecast generated for steel may be compared to a price forecast generated for copper. In this manner, users may determine whether trends in one commodity correlate to trends in other commodities.

The method may comprise displaying, by a graphical user interface, an overlay of two or more price forecasts of different scenarios related to the same decision evaluation. By way of example, a best-case scenario price forecast may be overlaid with a most probable scenario price forecast. In this manner, users may visualize the differences between scenarios.

The method may comprise generating, by one or more processors, guidelines based upon one or more decision evaluations. The guidelines may be adapted to be employed for training purposes and/or to set forth best practices.

The guidelines may be generated by comparing price forecasts to actual prices. That is, a price forecast may be evaluated by the actual behavior of a price over time.

The guidelines may be generated by comparing simulated purchases, simulated sales, and/or simulated utilizations to actual purchases, actual sales, and/or actual utilizations, respectively. That is, simulations may be compared to actual decisions by a business entity to determine how well the simulations cooperated with the decisions.

A neural network may be employed to generate guidelines. The neural network may compare forecasts to actual price behavior over time. The neural network may compare simulations of purchases, sales, and/or utilizations to actual purchases, actual sales, and/or actual utilizations, respectively. The neural network may recognize patterns and from the patterns, generate guidelines. By way of example, if a neural network recognizes that best case scenario price forecasts are consistently about 10-15% greater than the actual behavior of prices over time, the guidelines generated may direct users to adjust price forecasts by reducing them to better cooperate with the actual behavior of prices.

The method may comprise generating, by one or more processors, combinations of different evaluations of different commodities. The different commodities may be utilized for the production of alloys, mixtures, and/or blends. The alloys, mixtures, and/or blends may be of hypothetical materials. That is, the hypothetical materials may not have been produced. The hypothetical materials may be materials a business entity is considering to produce in the future.

The method may comprise defining a condition. The condition may trigger an alert when met. The condition may be related to one or more decision-influencing factors. The condition may account for one or more price forecasts, one or more updated prices, and/or any other decision-influencing factor discussed herein. By way of example, when a new price forecast is published or when the price of a commodity and/or product is updated, an alert may be triggered.

The method may comprise defining a rule. The rule may be associated with the one or more decision-influencing factors. The rule may determine the outcome of a contract based on one or more decision-influencing factors.

FIG. 1 illustrates a system according to the present teachings. The system comprises computing devices 12A, 12B in signal communication with one another via a network 20. The computing device 12A is operated by a first user 10A. The first user 10A may be researching and executing personnel. The computing device 12B is operated by a second user 10B. The second user 10B may be a stakeholder 10B. While one first user 10A and one second user 10B are illustrated in FIG. 1, the present disclosure contemplates multiple first users 10A and/or multiple second users 10B interacting with the system.

The computing device 12A receives historic price data 32, market commentary 34, and news 36 via the network 20. The historic price data 32 may originate from exchanges. The market commentary 34 and news 36 may originate from independent information providers and/or news outlets. The historic price data 32, market commentary 34, and news 36 assist the researching and executing personnel 10A to devise a price forecast 28 and one or more simulated purchases 30, as illustrated in FIG. 3. The historic price data 32, market commentary 34, news 36, price forecast 28, simulated purchases 30, or any combination thereof may be individually or collectively referred to herein as decision-influencing factors 26. The decision-influencing factors 26 are viewable on a user interface 18 (e.g., computer monitor) of the computing device 12A. The first user 10A (e.g., researching and executing personnel) is able to interact with the decision-influencing factors 26 via a user interface 18 (e.g., keyboard). For example, the first user 10A (e.g., researching and executing personnel) may apply filters to a graphical representation of historic price data 32, toggle between different types of graphical representations (e.g., line graphs and candlestick graphs) of historic price data 32, initially establish price forecasts 28 and/or simulated purchases 30, amend price forecasts 28 and/or simulated purchases 30, open and view market commentary 34 and/or news 36, or any combination thereof. Such viewing and interacting may be performed within a unitary page or window. In this manner, the users have all of the information they need in a single location and navigating or toggling between multiple pages, windows, and/or screens may be avoided.

The price forecast 28 includes forecasted prices of a commodity at one or more future dates, as illustrated in FIG. 3. For instance, the first user 10A (e.g., researching and executing personnel) may forecast prices of a commodity for the following four future fiscal quarters. With the price forecast established, the first user 10A (e.g., researching and executing personnel) can devise one or more simulated purchases 30 of a commodity. Each of the simulated purchases 30 include a quantity of a commodity purchased at a future date at a forecasted price, as illustrated in FIG. 3.

Typically, the date at which a commodity is purchased coincides with a forecasted price that is financially favorable to the business entity purchasing the commodity. That is, the forecasted price may be at or near a low over the period of future dates input into the price forecast. However, this is not necessarily the case. Business entities may purchase at forecasted prices other than the lowest or near-lowest price due to current stock of the commodity, production volume, financial resources, or any combination thereof. Business entities may also plan purchases at multiple future dates to arrive at a total payment for the commodity that is financially favorable.

The decision-influencing factors 26 are transmitted from the computing device 12A to the computing device 12B via the network 20. The computing device 12B receives the decision-influencing factors 26, which are displayed on a user interface 18 of the computing device 12B. The second user 10B (e.g., stakeholder) reviews the decision-influencing factors 26 and determines whether the purchase should be executed or the price forecast 28 or simulated purchases 30 should be amended. The second user 10B (e.g., stakeholder) may be able to amend the price forecast 28 and/or simulated purchases 30 directly and transmit the same back to the computing device 10B of the first user 10A (e.g., researching and executing personnel). If an amendment is required, the second user 10B (e.g., stakeholder) can communicate this to the first user 10A (e.g., researching and executing personnel), via the network 20. This back-and-forth communication between the first user 10A (e.g., researching and executing personnel) and second user 10B (e.g., stakeholder) may occur repeatedly until the decision is made for a purchase to be executed.

Historic price data 32, market commentary 34, and news 36 that are received and/or viewed by a first user 10A (e.g., researching and executing personnel) are autonomously stored as part of an immutable electronic ledger 24. Upon initially establishing and/or amending the price forecast 28 and simulated purchases 30, they are autonomously stored as part of the immutable electronic ledger 24. The immutable electronic ledger 24 is stored on a memory storage medium 16. The memory storage medium 16 is accessible by the computing devices 12A, 12B via the network 20.

FIG. 2 illustrates a method according to the present teachings. The method comprises receiving historical price data, market commentary and/or news, one or more price forecasts, and one or more simulated purchases. Upon receiving and/or viewing the historical price data and market commentary and/or news, they may be stored as a part of an immutable electronic ledger by a memory storage medium. Upon initially establishing and/or amending the price forecast and simulated purchases, they may be stored as a part of the immutable electronic ledger by a memory storage medium.

A total payment may be calculated based upon one of the price forecasts and simulated purchases. The total payment guides first users (e.g., researching and executing personnel) and second users (e.g., stakeholders) in deciding to execute a purchase. The price forecasts and/or simulated purchases may be amended, and the resulting total payment may be compared to prior versions. In this manner, the researching and executing personnel and stakeholders can explore different scenarios and ultimately decide which scenario is most likely to actually occur and which provides the most favorable total payment to the business entity.

The decision-influencing factors are transmitted to the second user (e.g., stakeholder). At this time, the second user may make a decision to take an action or not take an action. However, if questions or clarifications are raised or an amendment is requested, a decision may not have been made yet. The first user (e.g., researching and executing personnel) then receives a communication from the second user. The communication may authorize an action (e.g., purchase) be taken and thus, the action (e.g., purchase) may be taken (arrow A). The communication is stored as a part of the immutable electronic ledger by a memory storage medium. The communication may include questions or requests for clarification, which the first user (e.g., researching and executing personnel) would answer (arrow B). The communication is stored as a part of the immutable electronic ledger by a memory storage medium. The communication may request amendments to the price forecast and/or simulated purchase, which the first user (e.g., researching and executing personnel) may perform (arrow C). After such questions or clarifications, or amendments, a decision may be made that an action be taken or not taken. The communication is stored as a part of the immutable electronic ledger by a memory storage medium.

FIG. 3 illustrates a user interface 18. The user interface 18 graphically displays decision-influencing factors 26 including historic price data 32, market commentary 34, news 36, simulated purchases 30, and a price forecast 28. The historic price data 32, market commentary 34, and news 36 are provided to the researching and executing personnel and stakeholder in order to inform their decision-making. The underlined fields in the simulated purchases 30 are editable by the first user (e.g., researching and executing personnel) and/or second user (e.g., stakeholder). The forecast price may be automatically populated upon editing the fields in the price forecast 28. The fields may be edited to explore different scenarios for purchasing dates and quantities at respective forecasted prices and determine the total payment resulting from each scenario. The underlined fields in the price forecast 28 are editable by the first user (e.g., researching and executing personnel) and/or second user (e.g., stakeholder). The fields may be edited to explore different scenarios of what the price of the commodity may be at the specified time in the future. The system calculates the total quantity of the commodities in all of the simulated purchases. The system calculates the total payment of the commodities in all of the simulated purchases. The historic price data 32 is graphically displayed at the bottom of the user interface 18. The historic price data 32 is appended with the commodity prices entered in the price forecast 28.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. Other combinations are also possible as will be gleaned from the following claims, which are also hereby incorporated by reference into this written description. The omission in the following claims of any aspect of subject matter that is disclosed herein is not a disclaimer of such subject matter, nor should it be regarded that the inventors did not consider such subject matter to be part of the disclosed inventive subject matter.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers, and/or sections, these elements, components, regions, layers, and/or sections should not be limited by these terms. These terms may be used to distinguish one element, component, region, layer, and/or section from another region, layer, and/or section. Terms such as “first,” “second,” and other numerical terms when used herein do not imply a sequence or order unless clearly indicated by the context. Thus, a first element, component, region, layer, or section discussed herein could be termed a second element, component, region, layer, or section without departing from the teachings.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

Unless otherwise stated, any numerical values recited herein include all values from the lower value to the upper value in increments of one unit provided that there is a separation of at least 2 units between any lower value and any higher value. As an example, if it is stated that an amount is, for example, from 1 to 90, from 20 to 80, or from 30 to 70, it is intended that intermediate range values such as (for example, 15 to 85, 22 to 68, 43 to 51, 30 to 32, etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints.

The term “consisting essentially of” to describe a combination shall include the elements, components, or steps identified, and such other elements, components, or steps that do not materially affect the basic and novel characteristics of the combination. The use of the terms “comprising” or “including” to describe combinations of elements, components, or steps herein also contemplates embodiments that consist essentially of the elements, components, or steps.

The disclosures of all articles and references, including patent applications and publications, are incorporated by reference for all purposes. Other combinations are also possible as will be gleaned from the following claims, which are also hereby incorporated by reference into this written description.

### REFERENCE NUMERALS

Remake the table

What is claimed is:

1. A method for generating and maintaining an immutable electronic ledger, the method being stored as computer-executable instructions on a non-transitory memory storage medium, the method comprising:
one or any combination of:
(a) receiving from a user and/or a third-party source, one or more decision-influencing factors relating to a commodity and/or a product, the same being received by a computing device;
(b) accessing by the user and/or the third-party source, via the computing device, the one or more decision-influencing factors, the same being accessed on the computing device;
(c) receiving from the user and/or the third-party source, a modification to the one or more decision-influencing factors, the modification being received by the computing device; and
(d) receiving a direction from the user;
autonomously storing the one or more decision-influencing factors on the non-transitory memory storage medium as a part of the immutable electronic ledger, triggered by one or more of (a) through (d); and
applying a date and a time of storage to the one or more decision-influencing factors;
wherein the immutable electronic ledger serves as a record of the one or more decision-influencing factors, that is free of hindsight, for a business entity in an evaluation of a decision influenced by the one or more decision-influencing factors.

2. The method according to claim 1, wherein the method further comprises:
transmitting, via a network, the one or more decision-influencing factors from the computing device of the user to a second computing device of a second user so that the second user can review the one or more decision-influencing factors.

3. The method according to claim 2, wherein the method further comprises:
transmitting, via the network, a communication between the computing device and the second computing device;
autonomously storing on the non-transitory memory storage medium, the communication as a part of the immutable electronic ledger; and
applying to the communication a date and a time of storage.

4. The method according to claim 3, wherein the method further comprises:
displaying on a graphical user interface contents of the immutable electronic ledger relating to the evaluation of the decision;
wherein the contents of the immutable electronic ledger include only the one or more decision-influencing factors available contemporaneously with the evaluation of the decision.

5. The method according to claim 4, wherein the third-party source is a website accessible via the network.

6. The method according to claim 5, wherein receiving the one or more decision-influencing factors involve extracting, by the computing device, the one or more decision-influencing factors from the third-party source.

7. The method according to claim 6, wherein the immutable electronic ledger is centralized, such that a central authority controls the contents of the immutable electronic ledger.

8. The method according to claim 7, wherein the non-transitory memory storage medium is local to the computing device, a cloud server, or both.

9. The method according to claim 8, wherein the non-transitory memory storage medium is local to the computing device.

10. The method according to claim 9, wherein the method further comprises: defining a condition which triggers an alert when met, the condition being related to the one or more decision-influencing factors.

11. The method according to claim 5, wherein the method further comprises: defining a rule associated with the one or more decision-influencing factors.

12. The method according to claim 11, wherein the one or more decision-influencing factors include one or more price forecasts defined by a forecasted price of the commodity and/or product at one or more future dates, simulated purchases defined by a quantity of the commodity and/or the product to be purchased or considered to be purchased by the business entity at a future date at a forecasted price, simulated sales defined by a quantity of the commodity and/or the product to be sold or considered to be sold by the business entity at a future date at a forecasted price, simulated utilizations defined by a quantity of the commodity and/or product to be utilized or considered to be utilized by the business entity to produce a quantity of products at a future date, historical price data, updated prices, market commentary, news, price indexes, labor data, currency exchange rates, inflation rates, logistical costs, schedules, premiums, discounts, or any combination thereof.

13. The method according to claim 12, wherein the condition for triggering the alert accounts for the one or more price forecasts and/or the one or more updated prices.

14. The method according to claim 13, wherein the rule associated with the one or more decision-influencing factors determines the outcome of a contract.

15. The method according to claim 14, wherein the one or more decision-influencing factors relate to a price of the commodity and/or the product.

16. The method according to claim 15, wherein the method further comprises:
autonomously calculating, by the computing device, a price outcome of the one or more simulated purchases, simulated sales, simulated utilizations, or any combination thereof;
autonomously storing on the non-transitory memory storage medium, the price outcome as a part of the immutable electronic ledger; and
applying to the price outcome a date and a time of storage.

17. The method according to claim 16, wherein the method further comprises: receiving, by the computing device, a designation of best case scenario, worst case scenario, or most probable scenario, the designation being applied to the one or more simulated purchases, simulated sales, simulated utilizations, or any combination thereof; wherein the designation is applied by the user.

18. The method according to claim 17, wherein the method further comprises: displaying on the graphical user interface, the contents of the immutable electronic ledger including the one or more price forecasts, the one or more simulated purchases, the one or more simulated sales, the one or more simulated utilizations, or any combination thereof, compared against actual historic prices, actual purchases, actual sales, actual utilizations, or any combination thereof.

19. The method according to claim 18, wherein the method further comprises: displaying on the graphical user interface an overlay of two or more of the one or more price forecasts that are associated with different scenarios related to different evaluations over time; wherein the different evaluations relate to the commodities and/or the products, different commodities and/or different products, or both.

20. The method according to claim 19, wherein the method further comprises: displaying on the graphical user interface an overlay of two or more of the one or more price forecasts of different scenarios related to the same decision evaluation.
